(19) United States
(12) Patent Application Publication
(10) Pub. No.: US 2004/0268155 A1
(43) Pub. Date: Dec. 30, 2004

(54) Distributed control of fuel cell operation

(76) Inventor: Craig C. Andrews, College Station, TX (US)

Correspondence Address: STREETS & STEELE, 13831 NORTHWEST FREEWAY, SUITE 355, HOUSTON, TX, 77040, US

(21) Appl. No.: 10/862,118

(22) Filed: Jun. 4, 2004

Related U.S. Application Data
(60) Provisional application No. 60/475,740, filed on Jun. 4, 2003.

(51) Int. Cl. H04L 9/32

(52) U.S. Cl. 713/202

(57) ABSTRACT

System and method for distributed access to data or distributed control of a fuel cell, such as through a fuel cell test station. Each test station has a control computer that can be used to run the test station. A user can get remote access or control through an application server or a website host. A user must provide evidence of authorization in order to gain access to the system. Preferably, the system will further determine if an authorized user has privilege to connect to the test station in a requested mode, such as a control mode or read-only mode. Preferably, the system only allows one user to have control of a test station at any time. On site users may also be given higher priority.

This application is a continuation-in-part of U.S. Provisional Patent Application Ser. No. 60/475,740 filed on Jun. 4, 2003.

### BACKGROUND OF THE INVENTION

1. Field of the Invention

This invention relates to systems and methods for controlling a fuel cell, specifically including methods of controlling the fuel cell operating parameters during normal operation or testing.

2. Background of the Related Art

The primary components of a proton exchange membrane (PEM) fuel cell stack are the membrane and electrode assemblies (MEAs), gas diffusion layers, and bipolar plate/flow field assemblies. These components are assembled in a “stack” with each gas diffusion layer/MEA/gas diffusion layer in the stack separated by a bipolar assembly and each end of the stack having an endplate. Conventionally, the stack is held together under compression, such as by threaded tie rods or a series of bands, although the stack may be secured together with adhesives and the like. Internal or external manifold are provides to communicate reactants to the electrodes and carry away products or excess reactants.

Each of the cells in the stack has an MEA made up of a cathode electrode in intimate contact with one side of a proton exchange membrane (PEM) and an anode electrode in intimate contact with the opposite side of the proton exchange membrane. In the case of a hydrogen consuming PEM fuel cell, the anode electrode typically comprises an electrocatalyst layer and a porous hydrophobic gas diffusion layer/backing layer. Similarly, the cathode electrode of the PEM fuel cell typically comprises an electrocatalyst layer and a porous hydrophobic gas diffusion layer/backing layer. For a typical PEM electrolysis cell, the anode electrode comprises an electrocatalyst layer and a porous substrate/current collector material. Similarly, the cathode electrode of a typical PEM electrolysis cell comprises an electrocatalyst layer and a porous substrate/current collector material.

Operation of a fuel cell requires controllably supplying a fuel to the anodes, controllably supplying an oxidant to the cathodes, and providing a load that draws the electrical energy produced by the fuel cell. The load may be a device such as a light bulb, motor, or other electronic device that relies upon electricity for power (as in the operation of a fuel cell to generate electrical current to an operating device), or the load may be designed for the purpose of controllably dissipating electricity (as is typical in the testing of a fuel cell). The operation of a fuel cell may further include controllably humidifying the fuel and/or the oxidant, controlling the fuel and oxidant flow rates, controlling the fuel and oxidant pressures, and controlling stoichiometric flow of fluids in a load following mode. Operation of the fuel cell may further include monitoring cell or stack voltages, cell current, cell temperatures, impedance, water production, and fuel efficiency. The control and monitoring of these fuel cell operating parameters can be done with various equipment including mass flow controllers, back pressure regulators, solenoid valves, gas stream humidifiers, thermocouples, current or voltage sensors, and pressure sensors under the control of a computer operating process control software.

However, there is a need for a system that allows multiple users to interface with a fuel cell test station. It would be desirable if the system allowed access to fuel cell test station from various locations. It would also be desirable if the system allowed access to the fuel cell test station through web-based communications. Furthermore, it would be beneficial to have the system accept control instructions from authorized users and send automatic event notifications to certain users.

### SUMMARY OF THE INVENTION

One embodiment of the invention provides a method for distributed control of a fuel cell, comprising controlling the operation of the fuel cell with a dedicated local computer through the use of commands, communicating fuel cell operating data from the dedicated local computer to a server; and allowing an authorized user to access the fuel cell operating data on the server. In an alternative embodiment, a method is provided for distributed control of a plurality of fuel cells, comprising controlling the operation of each of the plurality of fuel cells with a dedicated local computer through the use of commands, communicating fuel cell operating data from the dedicated local computer to a server, and allowing an authorized user to access the fuel cell operating data from a remote computer.

Optionally, the methods may further include authorizing data access to a user that provides a user identification code or codes, such as a username and password, to the server that matches a user code in a list of authorized user identification codes maintained on the server. As a further option, the method may include allowing the authorized user to communicate commands to the dedicated local computer for control of the fuel cell test station, individual modules of the test station, or the fuel cell. Communication of commands or receive of data may be achieve through a server or a website host.

A preferred method further includes establishing a plurality of privilege levels, wherein each privilege level is associated with a set of the commands that are operable and wherein the server maintains a record of privilege levels assigned to each authorized user. Alternatively or in combination with use of privilege levels, the method may include establishing a plurality of priority levels, wherein the server maintains a record of priority levels for each authorized user, and allowing a first authorized user with a higher priority level than a second authorized user to provide commands to the dedicated local computer to the exclusion of the second authorized user. Optionally, the method may include decreasing the privilege level and/or the priority level associated with an authorized user when that authorized user is providing commands from a remote computer. In yet another optional embodiment, the method may include granting the highest priority level to an authorized user when that authorized user is providing commands to the dedicated local computer on site.

In another embodiment, a method is provided for distributed control of a plurality of fuel cells, comprising controlling the operation of each of the plurality of fuel cells with a dedicated local computer through the use of commands, communicating fuel cell operating data from the dedicated local computer to a server, and allowing an authorized user to access the fuel cell operating data from a remote computer.

### BRIEF DESCRIPTION OF THE DRAWINGS

FIG. 1 is a schematic diagram of a distributed control system that includes various embodiments of the invention.

### DETAILED DESCRIPTION OF A PREFERRED EMBODIMENT

The present invention provides a distributed control strategy for operating a fuel cell, such as through a fuel cell test station. Each test station has a control computer that can be used to run the test station, however, the test station can be run remotely. An application server is a server computer that has on it a database for centralized data storage, programmable data logging, programmed test scripts as well as user identification, privilege and priority information. Authorized users can access the test station through a standard computer equipped with a web browser. A user first connects to the application server where they will be required to supply acceptable credentials (such as a username and password) and indicate the requested type of connection (such as “control” or “read-only”).

Once the user has been authorized, the application server will determine if the user has privilege to connect to the test station in the requested control mode. If the application server determines that the user is authorized, then the user will be redirected to the test station in the requested control mode. User privileges are typically setup in advance in an application server database. It is preferably to configure the system so that only one user can have control of a test station at any time, such that the test station will reject a request for control when another user is already controlling the test station. Optionally, user priorities may also be established within the application server or the test station such that the user with the highest priority is granted control.

Once connected, the test station graphical interface is displayed to the user. The user can then select test scripts and assign them to individual test modules as well as run the assigned scripts. The term “test module,” as used herein, refers to an identifiable component or unit operation of the test station, such as a gas humidifier, AC impedance, gax mixer, and electronic loads. Preferably, each test module can be individually started, stopped, and assigned scripts. While the programmed test is running, data is logged into the database on the application server. Additional users can connect to the test station in a similar fashion. A connection to the application server is made where the user will supply credentials along with the requested connection type, and once verified the user will be checked for privilege to connect in the requested control type against the user database, and if the credentials and privileges are sufficient, then the user will be redirected to the test station in the requested control mode. If a remote user requests a connection to a test station in control mode and the test station is already being controlled by another user, the second connecting user will be denied control but will have the option to connect in “read-only” mode. Any number of users can be connected to a test station in “read-only” mode.

It is anticipated that certain special rules of priority should be established, such as that a local authorized user will always have rights to override a user obtaining access through a remote computer and seize control of the test station. This prioritization of local users is important for safe operation of the test station, since a local user may have additional visual information or other information not available to the remote user.

The graphical user interface (GUI) is implemented in a hypertext markup language (HTML) framework that is exposed to the user for easy customization of the user interface. Using an HTML editor the user can layout a screen and dynamically link data fields to defined tag labels or virtual tags in the control engine. Users can create custom controls and place these controls in the HTML pages. They can also add tabs to the display to break apart complex user interfaces into several simplified displays.

In one embodiment, the process control software on the local computer forming part of the test station provides an interface to a website host and exchanges of information between the website and software occur via the automation interface in the software. The process control software will retain direct control of all aspects of the test equipment, but control parameters, variables, and scripts, for example, may be passed between the website and the process control software. The extension of process control software to networking control may be accomplished through either the web site or through distributed copies of the process control software. At any time, additional pages can be added to the website for product quality control reports, basic data display and control, etc., but for primary control of the test equipment it is preferred that the distributed copies of the process control software be used for distributed control.

Using the distributed control feature of the process control software, users will have the option of connecting to the computer directly controlling the test equipment or the ‘local’ computer (local to the test equipment). Users may then operate the process control software on a remote computer and any number of authorized users will have access to the status of the test station. The individual control of a user's access authority will be maintained by the local computer, but those users having sufficient control authority or privileges may request a ‘token’ from the local computer. If a remote user is granted this token, the remote user may then open any of the features of the process control software (such as logging, scripting, and custom control) and take control of that function. Since the remote user is running the same version of the process control software, the look and feel will be identical to the local process control software.

At any time, a local user that is logged into the local computer may reclaim the token (take priority), in effect locking out the remote user from the control mode. Likewise, a local user may refuse the token request, in effect not allowing the remote user to gain control in the first place. The token is configured (priority is handled) in this manner since it must be presumed that a user standing at the test station has more intimate knowledge of the test status.

In most configurations, it is preferable to use remote copies of the process control software to control the test station. This simplifies software maintenance and provides a common look and feel while providing all of the features and benefits of the original program. Having multiple installations of the software allows scripts to be written and tested ‘off-line’ from the test equipment as well as data analyzed. While in remote (distributed) control of the test station, using the process control software on the remote computers also improves the response rate to the remote user since only the parameters of interest need to be exchanged between the local copy of the process control software controlling the hardware and the remote copy of the process control software requesting the control token.

In contrast, when using distributed control through the web page and browser, all graphical information including the format of tables, input boxes, data display, involves the transmittal of extensive information, potentially limiting the features that can be provided in remote mode. Interaction of the test station through the web page also requires a substantial investment in software that duplicates software already provided in the process control software. However, there are certain applications that are more easily accomplished through a web type interface than through the process control software directly. These include simple control and display of predefined data and variables, the creation of forms and other documentation, such as for quality assurance, and ‘drag-and-drop’ programming abilities through readily available tools such as FRONTPAGE (a trademark of Microsoft Corporation of Seattle, Wash.). An additional benefit of web browser control of the test equipment is that it allows control and monitoring using a computer that does not have custom software (e.g., the process control software), such as public use computers at airports, etc. Therefore, the process control software on the test station will preferably allow the user to remotely control the test station through either of these means as selected by the user, namely either using a computer with a distributed copy of the process control software or a computer with a browser that exchanges data with a web page allowing any number of additional custom web pages to be provided.

An optional embodiment provides a system snapshot feature may also be provided to the process control software to enhance the user's ability to obtain status information of the system should a hardware or software shutdown occur. During operation of the test station, data and status information will be continuously collected, preferably at one second intervals, and stored in a circular queue, such as a queue containing 60 seconds worth of data representing every variable in the system. Each minute this queue will overwrite itself on the hard drive of the computer to ensure that the data is available even if the system upset is caused by a computer or software failure. The user may configure system parameters, such as temperatures and pressures, which are defined as events that should be recorded. Each time an ‘event’ is detected, the snapshot data file name will be changed so that a permanent record is provided of the status of the equipment and process conditions at the moment of the event. The file name will be incremented so that subsequent snapshot queues are written to a separate file should another event occur.

A further optional embodiment provides an alarm manager feature in the process control software to provide a means of contacting individuals through email, numeric pagers, or the telephone. Upon the occurrence of user-specified events, the software will contact the listed parties through the listed mechanisms. If an email address is listed as a means of contact, then an email message will be sent to each contact. Preferably, this email message will specify the triggering event and will include the system snapshot (as discussed above) attachment. If a telephone number is provided as contact information, the user will have the ability, during setup of the software, to specify an audible or numeric message to be sent. Should the telephone number be a numeric pager, the corresponding text message will be delivered to each contact. Should the telephone number be an answering machine or person, the audible or numeric message will be played. During software setup, the user may select their audible or numberic messages such that a recognizable tune, sequence of tones, or voice synthesis is played.

One non-limiting example of a fuel cell test system includes at least the following components:

A gas mixing unit providing one or more of the following gases to the respective electrodes:

Cathode: Air (or oxygen): between 2 and 100 standard liters per minute (slpm)

Anode: Air (or oxygen) between 1 and 50 slpm; N₂ between 1 and 50 slpm; H₂ between 1 and 50 slpm; CO between 1 and 50 slpm; and CO₂ between 0.4 and 20 slpm

Mass flow controllers: Range: 2% F.S., Accuracy: 1% F.S.

Anode and cathode gas outlets have a pressure controller to “dampen” gas pressure to the stack.

Anode purge system includes a rotometer or control valve for adjustable flow control. This rotometer may be closed in the event of an E-Stop, Warm-up, cool down, low gas inlet pressure, low flow, power failure, etc.

Cathode purge system includes a rotometer for adjustable flow control and is closed in the event of an E-Stop, Warm-up, cool down, low gas inlet pressure, low flow, power failure, etc.

Electronic load:

Max Current: 1000 Amps Max (for example, supplied with a 20 amp and 100 amp shunt)

Max Voltage: 55 Volts

Max Load: 1 Kw

Programmable load. Control in constant current, constant voltage, or constant power

Interfaces with hardwire safety interlock

Computer System

RS 232-RS 485 Converter

Computer will preferably meet or exceed:

1. PENTIUM 4 (a trademark of Intel Corporation), 1.8 GHz, 256 Cache

2. 512 MB, NonECC, PC133 SDRAM, 1×512 Memory

3. Keyboard

4. 16MB ATI, Rage Ultra 128 Video Card

5. 20 GB EIDE, 7200 RPM, ATA/100 Hard Drive

6. 3.5″, 1.44 MB Floppy Drive

7. WINDOWS 2000 (a trademark of Microsoft Corporation of Seattle, Wash.)

8. Mouse

9. Integrated 10/100 Remote Wake-Up NIC

10. 24X CD-ROM, 16X CDR-RW drive

11. Sound Card

12. Monitor, 19″

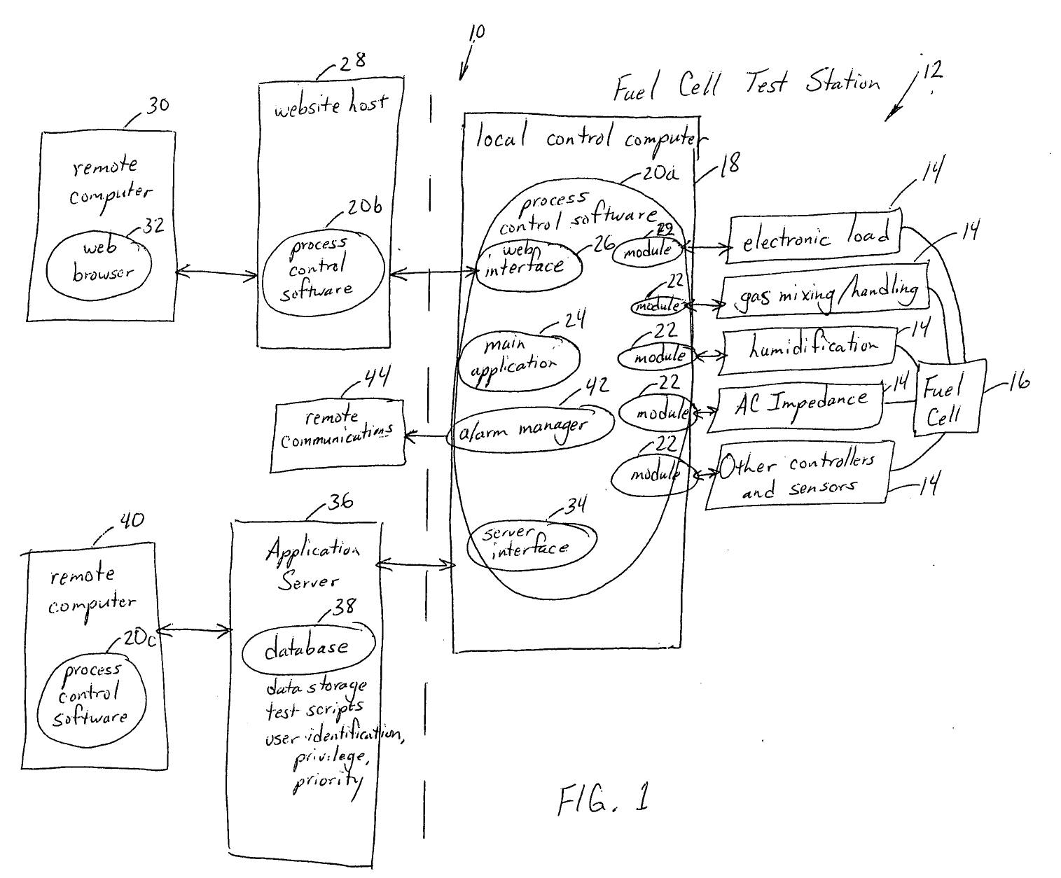

FIG. 1 is a schematic diagram of one specific embodiment of a distributed control system in accordance with the invention. The system 10 includes a fuel cell test station 12 that includes various test modules 14 that interface with the fuel cell under test 16. The test modules 14 receive control signals from a local control computer 18 and send operating parameters and measurements to the computer 18. The computer 18 operates process control software 20a having a software module 22 that interfaces with each of the test modules 14. The software 20a also includes a main application 24 that coordinates data handling and displays.

In accordance with one embodiment of the invention, the process control software includes a web interface 26 that communicates parameters of the fuel cell test to a website host 28, preferably having another copy or version of the process control software 20b. A remote computer 30 having a web browser 32 is thus allowed to access the website host 28 over a global communications network, such as the internet. If the user operating the remote computer 30 has authorization, computer 30 may receive fuel cell test parameters, as well as graphics, to monitor the fuel cell test or access prior fuel cell test data. As described previously, if the user operating remote computer 30 has sufficient privileges and priority, then computer 30 may further send control signals, such as new operational setpoint parameters or scripts, to the fuel cell test station 12 via the website host 28.

In accordance with another embodiment of the invention, the local control computer 18 may include a server interface 34 that manages communications between the process control software 20a and an application server 36. The application server 36 has a database 38 containing data storage, test scripts, and user identification, privilege and/or priority information. A remote computer 40 having a copy of the process control software 20c can communicate with the application through various means, such as private network or a dial-up connection. If a user of the computer 40 has authorization, then the computer may receive parameters of the fuel cell test from the application server 36. Since the computer 40 already has process control software 20c, there is generally no need to transmit graphical information. This provides various advantages, including transmission speed and full functionality. Furthermore, if the user of computer 40 has sufficient privileges and priority, then the test station will accept control signals, such as new operational setpoint parameters or scripts, received through the application server 36 from the computer 40.

In a further embodiment of the invention, the process control software 20a of the local control computer 18 may include an alarm manager 42 that may initiate various signals to various remote communications devices 44. Upon detection of an alarm, the alarm manager 42 may execute a set of instructions to notify certain devices with certain information. For example, the alarm manager may be programmed to send a notification by pager to a fuel cell project manager if a high temperature is detected in the fuel cell 16. Other means, such as email and phones, may also be programmed for use upon the occurrence of specific alarms. Alarms are not limited to negative events, but may also be used to provide notice of longevity milestone, operational efficiency, or completion of a polarization curve.

### EXAMPLE

A software system providing both local and remote control of a fuel cell test system was developed and tested. The software system was composed of a main application and a number of independent modules. Each of the independent modules provided a set of system variables plus a user interface for controlling a particular instrument or component of a fuel cell test system. The main application provided common data manipulation and display functionality such as charting, logging, custom scripting, and custom user interfaces. The main application and the independent modules each utilized an independent remote procedure call mechanism in order to accomplish the remote control of the entire fuel cell test system.

Each of the independent software modules was structured the same way regardless of what type of actual hardware it controlled. Each module was logically divided into a server portion capable of communicating with the hardware component and a client portion capable of interacting with the user. A set of variables was defined which provided all monitoring and control capabilities for that particular hardware component. For example, one variable might provide the present temperature of a fuel cell (for monitoring) while another variable would contain the desired temperature of the fuel cell (for control). This set of variables was independently instantiated by both the client and the server and synchronized between the two at regular intervals (such as once per second) using a remote procedure call mechanism. Remote procedures were called by the client portion (the client) and executed by the server portion (the server). These procedures allowed the client to get the present values of the variables, as well as set the value of a variable. A dedicated background thread in the client executed the synchronization procedure. The use of a background thread and special synchronization procedure allowed the user to read and write variable values in the client at virtually any time without any delays incurred by the remote procedure call. The synchronization procedure consisted of a multi-step process. First, the client reads the value of all variables from the server into a temporary copy. During this procedure call, the user is free to read and write the values of the client variables. Once this procedure call completes, the client variables are briefly locked to restrict user access using a critical section thread synchronization mechanism. While the variables are locked, the unmodified client variables are updated from the values in the temporary copy that was previously read from the server. The modified client variables are copied out into a temporary buffer for later writing to the server. Once the modified client variables are copied out, the client variables are unlocked so that the user is once again free to read and write them. Then the modified variables are written to the server using remote procedure calls. Since only local memory copies are performed while the client variables are locked, there is no perceptible restriction to user access. Also, this structure allows multiple clients to be connected to a single server.

The main application provided the mechanism for starting each of the independent software modules and bringing their variables and user interfaces together into a comprehensive fuel cell test system control application. The main application was configurable either for local control or for remote control. For local control, both the client portion and the server portion of each independent software module was loaded and run on the local machine. For remote control, the main application must be running in local mode on a host machine. Once the host application is running, the main application can be run on a different machine, communicating with the host using a remote procedure call mechanism. Procedures are provided to allow the remote application to identify which independent software modules are running on the host. Once the remote application identifies the independent software modules, it loads and runs the client portion only of the independent software module and connects them back to their respective servers running on the host. This allows the user to interact with the remote client's variables and user interface the same way as on the host.

The remote procedure call mechanism used in the software system was implemented using a custom TCP/IP network protocol. This mechanism allowed software procedures to be executed on a remote machine over the standard TCP/IP internet network protocol. Alternatively, some other form of remote procedure call could be used such as Microsoft's DCOM architecture provided by the WINDOWS operating system.

The present invention includes the methods, systems, and computer program products described above. It should be understood from the foregoing description that various modifications and changes may be made in the preferred embodiment of the present invention without departing from its true spirit. It is intended that this description is for purposes of illustration only and should not be construed in a limiting sense. Only the language of the following claims should limit the scope of this invention.

What is claimed is:

1. A method for distributed control of a fuel cell, comprising:
(a) controlling the operation of the fuel cell with a dedicated local computer through the use of commands;
(b) communicating fuel cell operating data from the dedicated local computer to a server; and
(c) allowing an authorized user to access the fuel cell operating data on the server.

2. The method of claim 1, further comprising:
(d) authorizing data access to a user that provides a user identification code to the server that matches a user code in a list of authorized user identification codes maintained on the server.

3. The method of claim 2, wherein the user identification code includes a username and password.

4. The method of claim 1, further comprising:
(d) allowing the authorized user to communicate commands to the dedicated local computer for control of the fuel cell.

5. The method of claim 1, further comprising:
(d) allowing the authorized user to communicate commands to the dedicated local computer through the server for control of the fuel cell.

6. The method of claim 5, further comprising:
(e) establishing a plurality of privilege levels, each privilege level being associated with a set of the commands that are operable; and
(f) the server maintaining a record of privilege levels assigned to each authorized user.

7. The method of claim 5, further comprising:
(g) establishing a plurality of priority levels, the server maintaining a record of priority levels for each authorized user;
(h) allowing a first authorized user with a higher priority level than a second authorized user to provide commands to the dedicated local computer to the exclusion of the second authorized user.

8. The method of claim 6, further comprising:
(i) decreasing the privilege level associated with an authorized user when that authorized user is providing commands from a remote computer.

9. The method of claim 7, further comprising:
(i) decreasing the priority level associated with an authorized user when that authorized user is providing commands from a remote computer.

10. The method of claim 7, further comprising:
(i) granting the highest priority level to an authorized user when that authorized user is providing commands to the dedicated local computer on site.

11. A method for distributed control of a plurality of fuel cells, comprising:
(a) controlling the operation of each of the plurality of fuel cells with a dedicated local computer through the use of commands;
(b) communicating fuel cell operating data from the dedicated local computer to a server; and
(c) allowing an authorized user to access the fuel cell operating data from a remote computer.

12. The method of claim 11, further comprising:
(d) authorizing data access to a remote computer user that provides a user identification code to the server that matches a user code in a list of authorized user identification codes maintained on the server.

13. The method of claim 12, wherein the user identification code includes a username and password.

14. The method of claim 11, further comprising:
(d) allowing the authorized remote computer user to communicate commands to the server.

15. The method of claim 11, further comprising:
(d) allowing the authorized remote computer user to communicate commands to the dedicated local computer through the server.

16. The method of claim 15, further comprising:
(e) establishing a plurality of privilege levels, each privilege level being associated with a set of the commands that are operable; and
(f) associating a privilege level with each user identification code on the server.

17. The method of claim 16, further comprising:
(g) establishing a plurality of priority levels, each user identification code being assigned a priority;
(h) allowing a first authorized user with a higher priority level than a second authorized user to provide commands to the dedicated local computer to the exclusion of the second authorized user.

18. The method of claim 16, further comprising:
(i) decreasing the privilege level associated with an authorized user when that authorized user is providing commands from a remote computer.

19. The method of claim 17, further comprising:
(i) decreasing the priority level associated with an authorized user when that authorized user is providing commands from a remote computer.

20. The method of claim 17, further comprising:
(i) granting the highest priority level to an authorized user when that authorized user is providing commands to the dedicated local computer on site.
